(19) United States
(12) Patent Application Publication
(10) Pub. No.: US 2014/0287783 A1
(43) Pub. Date: Sep. 25, 2014

(54) METHODS AND APPARATUSES FOR USE IN DETERMINING A LIKELY MOTION STATE OF A MOBILE DEVICE

(71) Applicant: QUALCOMM Incorporated, San Diego, CA (US)

(72) Inventors: Joseph Czompo, San Jose, CA (US); Guttorm R. Opshaug, Redwood City, CA (US)

(73) Assignee: QUALCOMM Incorporated, San Diego, CA (US)

(21) Appl. No.: 14/162,356

(22) Filed: Jan. 23, 2014

Related U.S. Application Data
(60) Provisional application No. 61/804,565, filed on Mar. 22, 2013.

(51) Int. Cl. H04W 4/02

(52) U.S. Cl. CPC H04W 4/027
USPC 455/456.6; 455/556.1

(57) ABSTRACT

Techniques are provided which may be implemented within a mobile device for determining a likely motion state of the mobile device. In an example, a mobile device may obtain sets of measurement signals from an inertial sensor, determine corresponding measures of variation for each of the sets of measurement signals, determine flatness indications corresponding to sets of the measures of variation, determine a motion state threshold level based, at least in part, on one or more flatness indications; and determine a likely motion state of the mobile device based, at least in part, on the motion state threshold level and one or more of: (i) a subsequently determined measure of variation, and/or (ii) a subsequently determined flatness indication.

### CLAIM OF PRIORITY UNDER 35 U.S.C. §119

This patent application claims benefit of and priority to co-pending U.S. Provisional Patent Application 61/804,565, filed Mar. 22, 2013, entitled, “METHODS AND APPARATUSES FOR ZERO MOTION DETECTION AND APPLICATION”, and which is assigned to the assignee hereof and incorporated herein by reference.

### BACKGROUND

1. Field

The subject matter disclosed herein relates to electronic devices, and more particularly to methods, apparatuses and articles of manufacture for use by one or more electronic devices in characterizing an estimated location of a mobile device, and attempting to affect an accuracy of, and/or an uncertainty corresponding to, a subsequent estimated location of the mobile device that is determined based, at least in part, on one or more wireless signals received by the mobile device from one or more terrestrial-based transmitting devices.

2. Information

As its name implies, a mobile device may be moved about, e.g. typically being carried by a user and/or possibly a machine. By way of some non-limiting examples, a mobile device may take the form of a cellular telephone, a smart phone, a tablet computer, a laptop computer, a wearable computer, a navigation and/or tracking device, etc.

A position and/or movements of a mobile device may be determined, at least in part, by a positioning and/or navigation capability (herein after simply referred to as a positioning capability) that may be implemented on board the mobile device, in one or more other electronic devices, and/or some combination thereof. Certain positioning capabilities may be based on one or more wireless signals transmitted by one or more transmitting devices and acquired by mobile device. By way of example, certain wireless signal-based positioning capabilities make use of wireless signals acquired from a satellite positioning system (SPS), such as, e.g., the global positioning system (GPS), etc.

In another example, certain wireless signal-based positioning capabilities make use of wireless signals acquired from terrestrial-based wireless transmitting devices, such as, e.g., a dedicated positioning Beacon transmitting device, an access point (AP) device which may be part of a wireless local area network, a base transceiver station which may be part of the cellular telephone system, and/or the like or some combination thereof. In certain implementations, a positioning capability may make use of one or more electronic files, such as, e.g., an electronic map, a routability graph, a radio heatmap, and/or the like or some combination thereof, to determine a position and/or other movements of the mobile device within a particular environment.

Further still, some mobile devices are provisioned with various sensors, such as inertial sensors, the outputs of which may be considered in some manner in determining various movements and/or the orientation of a mobile device in support of various processes. For example, inertial sensor measurements may support positioning/navigation processes. Accordingly, it may be beneficial to calibrate or otherwise consider such inertial sensors at particular times.

### SUMMARY

In accordance with certain aspects, a method may be provided which comprises, at a mobile device: obtaining sets of measurement signals from an inertial sensor; determining corresponding measures of variation for each of the sets of measurement signals; determining flatness indications corresponding to sets of the measures of variation; determining a motion state threshold level based, at least in part, on one or more flatness indications; and determining a likely motion state of the mobile device based, at least in part, on the motion state threshold level and one or more of: (i) a subsequently determined measure of variation, and/or (ii) a subsequently determined flatness indication.

In accordance with certain aspects, a mobile device may be provided which comprises: an inertial sensor; and a processing unit to: obtain sets of measurement signals from the inertial sensor; determine corresponding measures of variation for each of the sets of measurement signals; determine flatness indications corresponding to sets of the measures of variation; and determine a motion state threshold level based, at least in part, on one or more flatness indications; and determine a likely motion state of the mobile device based, at least in part, on the motion state threshold level and one or more of: (i) a subsequently determined measure of variation, and/or (ii) a subsequently determined flatness indication.

In accordance with certain aspects, an article of manufacture may be provided, which comprises a computer readable medium having stored therein computer implementable instructions executable by a processing unit of a mobile device to: obtain sets of measurement signals from an inertial sensor; determine corresponding measures of variation for each of the sets of measurement signals; determine flatness indications corresponding to sets of the measures of variation; determine a motion state threshold level based, at least in part, on one or more flatness indications; and determine a likely motion state of the mobile device based, at least in part, on the motion state threshold level and one or more of: (i) a subsequently determined measure of variation, and/or (ii) a subsequently determined flatness indication.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram illustrating an arrangement of representative electronic devices including a mobile device capable of determining its likely motion state, in accordance with an example implementation.

FIG. 2A is a flow diagram illustrating an example process that may be implemented in a mobile device to determine its likely motion state, in accordance with an example implementation.

FIG. 2B is a flow diagram illustrating an example process that may be implemented in a mobile device to determine its likely motion state, in accordance with certain further example implementations.

FIG. 3 is a graph illustrating certain characteristics that may observable or otherwise considered by various techniques provided herein for determining a likely motion state of a mobile device, in accordance with an example implementation.

FIG. 4 is a flow diagram illustrating an example process that may be implemented in a mobile device to support a determination regarding its likely motion state, in accordance with certain further example implementations.

FIG. 5 is a flow diagram illustrating an example process that may be implemented in a mobile device to support a determination regarding its likely motion state, in accordance with certain further example implementations

FIG. 6 is a schematic diagram illustrating certain features of an example special purpose computing platform that may be provisioned within a mobile device capable of determining its likely motion state, in accordance with an example implementation.

### DETAILED DESCRIPTION

Various techniques are described herein which may be implemented in a mobile device capable to determine its likely motion state, in accordance with an example implementation.

In certain example implementations, a mobile device comprising may determine its likely motion state based, at least in part, on one or more inertial sensors. For example, a likely motion state may indicate that the mobile device is in a static state or a non-static state. A static state may correspond to the mobile device remaining substantially still, e.g., relative to a point identified within a referenced coordinate system or the like which may be applied to a particular environment. Conversely, a non-static state may correspond to the mobile device that may be in some state of motion that is different from a static state.

For example, while a mobile device is resting on a table top in a hotel lobby it may deemed to be in a static state until moved. If a person picks up the mobile device and carries it away from the table top, then such mobile device may be deemed to have transitioned to a non-static state. As may be appreciated, there may be other movements of the mobile device which may or may not be sensed and/or deemed to represent a transition in from one motion state to another motion state. For example, if the table were to have been bumped or otherwise experience certain vibrations a decision may be made that the resulting sensed movements fall below a threshold level of movement and/or were of such short duration to determine that a previously determined static state of the mobile device may remain unchanged. Likewise, in certain instances, if the mobile device was briefly moved a relatively short distance (e.g., 100 cm) on the desktop, such movement may not induce a change in the likely motion state.

Of course, some motion state determinations may depend on the purpose and/or context for the motion state decision and/or a capability of the inertial sensor(s). For example, a motion state determination that may support a positioning or navigation process (e.g., corresponding to movement of a person or machine within a particular environment) may permit significant movements of a mobile device while deemed to be in a static state. For example, a mobile device may be moved within a small region (e.g., 1-2 meters) of space and/or rotated in some manner while remaining in a static state for the purposes of navigation. However, such movements may be deemed to represent non-static motion for certain other purposes, such as, e.g., calibrating a bias or other parameter(s) corresponding to measurement signals from an accelerometer, a gyroscope, and/or the like. Consequently, it may be beneficial to consider different motion state threshold levels (e.g., of sensed movement and/or the like) when determining a likely motion state of a mobile device with regard to different purposes, under different contexts, etc.

In certain instances, it may be possible to predetermine a motion state threshold level that may indicate a transition from one motion state to another motion state for situations such as those described above regarding the static state (sitting on a table) and a non-static state (moving within and/or out of the hotel lobby).

However, in some instances, it may be impracticable or otherwise less useful to predetermine certain motion state threshold levels for certain purposes, contexts, conditions, etc. For example, consider a situation wherein a mobile device is located within a vehicle or other like machine that may itself transition between similar motion states, e.g., a motion state, a parked state, an idling state, etc. Hence, in accordance with certain aspects of the present description, it may be possible in certain instances for a mobile device to monitor measurement signals from one or more inertial sensors over time and dynamically and/or adaptively determine one or more motion state threshold levels corresponding to one or more transitions from one motion state to another motion state, which may be applied, at least in part, in determining a likely motion state of the mobile device.

In certain example implementations, a mobile device may obtain sets of measurement signals from an inertial sensor (e.g., an accelerometer, a gyrometer/gyroscope). A set of measurement signals may, for example, comprise digital signals representing certain raw or processed sensed inertial movements in some manner that may have been sampled or otherwise gathered over some period of time, and may pertain to a particular sensed dimension, e.g., regarding a particular axis (x, y, z), and/or a particular rotation (roll, pitch, yaw, about a respective axis x, y, z). For example, a set of measurement signals may be obtained for an x-axis accelerometer over some period of time. For example, a set of measurement signals may be obtained for a yaw (rotation about a z-axis) measurement of a gyroscope over some period of time.

Those skilled in the art should recognize that the period of time corresponding to a set of measurement signals may vary, e.g., depending on the inertial sensor, a purpose or context associated with the measurement signals, a level of accuracy/precision, and/or other like reasons or some combination thereof. Hence, in certain instances, a period of time for a set of measurement signals may be as low or lower than 1 ms and as high or higher than 1 second. In certain instances, two or more periods of time for two or more sets of measurement signals may be temporally adjacent and/or otherwise substantially temporally contiguous. In certain instances, two periods of time for two sets of measurement signals may be temporally separated by another period of time. Moreover, in certain implementations, measurement signals obtained during a period of time may result from discrete time sampling.

Having obtained a plurality of sets of measurement signals, a mobile device may determine corresponding measures of variation for each of the sets of measurement signals. For example, a measure of variation may be based, at least in part, on a mean variance, and/or the like for each set of measurement signals.

A plurality of measures of variation may be included in a set of measures of variation and a mobile device may determine a corresponding flatness indication for the set of measures of variation. For example, a flatness indication for a set of measures of variation may be based, at least in part, on a mean variance, and/or the like for the set of measures of variation.

A mobile device may, for example, determine a motion state threshold level based, at least in part, on one or more flatness indications. For example, a mobile device may determine a motion state threshold level that may be applied to determine a transition from a static motion state to a non-static motion state, and/or from a non-static motion state to a static motion state. Accordingly, in certain example implementations, one or more motion state threshold levels may be dynamically and/or adaptively determined by a mobile device.

A mobile device may subsequently determine (or verify) a likely motion state of the mobile device based, at least in part, on at least one motion state threshold level and one or more of: (i) a subsequently determined measure of variation, and/or (ii) a subsequently determined flatness indication.

If two or more motion state threshold levels are available, a mobile device may select one of the two or more motion state threshold levels for use in determining the likely motion state of the mobile device based, at least in part, on a previously determined likely motion state. Thus, for example, if a previously determined likely motion state indicates a static motion state, then a motion state threshold level indicative of a transition from such a static state to another state (e.g., a non-static state) may be selected. Similarly, for example, if a previously determined likely motion state indicates a non-static motion state, then a motion state threshold level indicative of a transition from such a non-static state to a static state may be selected. While the examples presented herein tend to relate to determining whether a likely motion state is a static state and non-static state, it should be understood that the techniques presented herein may be adapted to three or more motion states. Hence, in certain instances (e.g., for certain purposes, contexts, etc.) there may be different types of static motion defined (e.g., a vibrating static motion, a non-vibrating static motion, a power saving static mode, etc.), and/or different types of non-static motion (e.g., a linear non-static motion, a non-linear static motion, etc.), just to name a few examples.

In certain example implementations, if two or more motion state threshold levels are available, a mobile device may select one of the two or more motion state threshold levels for use in determining the likely motion state of the mobile device based, at least in part, on supplemental evidence of motion state that may be obtained by the mobile device. Thus, in certain instances, a mobile device may obtain supplemental evidence of motion state based, at least in part, on one or more wireless signals acquired by the mobile device. For example, certain changes over time in one or more signal characteristics of a wireless signal acquired by the mobile device from a transmitter having a known fixed or other determinable location may be indicative of a likely motion state. In certain instances, a mobile device may obtain supplemental evidence of motion state based, at least in part, on a user input, e.g., obtained by the mobile device via one or more user input units/devices. For example, a user may indicate a likely motion state in response to an inquiry via a touchscreen/display, microphone/speaker, etc. In certain instances, a mobile device may obtain supplemental evidence of motion state based, at least in part, on another sensor provisioned within the mobile device. For example, changes or lack thereof in measurements (e.g., represented by one or more electrical signals) from a magnetometer may provide supplemental evidence of certain motion states (e.g., some changing magnetic fields may indicate a likely non-static motion state, and some unchanging or less changing magnetic fields may indicate a likely static motion state).

In certain example implementations, a mobile device may affect one or more processes based, at least in part, on a determined likely motion state. For example, in certain instances a calibration, testing, and/or other like process corresponding to one or more sensors (inertial and/or environmental) may be affected based, at least in part, on a determined likely motion state.

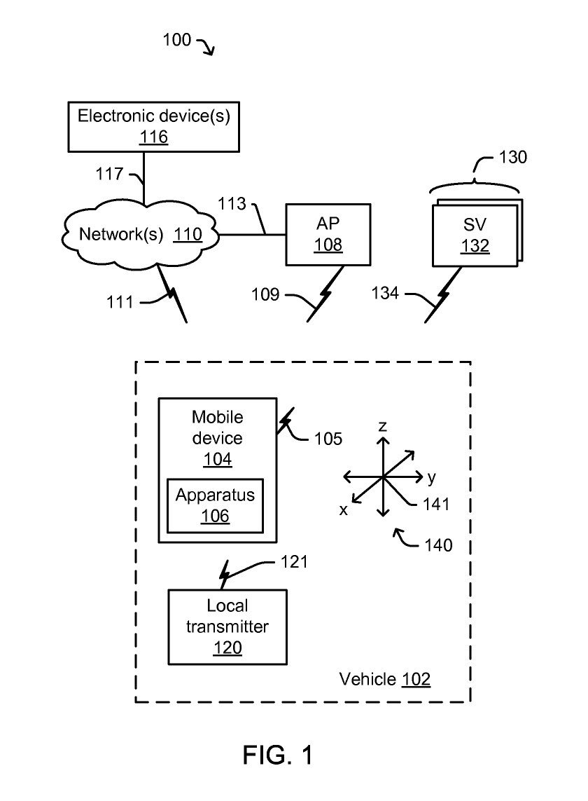

Attention is drawn to FIG. 1, which is a schematic block diagram illustrating an example arrangement 100 comprising various example electronic devices, including a mobile device 104 having an apparatus 106. Mobile device 104 and/or apparatus 106 may be configured to determine a likely motion state of mobile device 104. As previously mentioned, in certain example, implementations, a likely motion state may indicate that mobile device 104 is in a static motion state or a non-static motion state. In some instances, mobile device 104 may be located within and hence moved in some manner by a vehicle 102 and/or the like. Such a likely motion state may correspond to movements or lack thereof of mobile device 104 within respect to a coordinate system 140 (e.g., represented here by intersecting x-axis, y-axis, and z-axis).

In certain implementations mobile device 104 may communicate (transmit and/or receive signals) with one or more other electronic devices over one or wired or wireless communication links, such as, e.g., communication link 105. For example, via one or more of communication links 105, 111, 117 and network(s) 110, mobile device 104 may, in certain implementations, communicate with one or more electronic device(s) 116 (e.g., one or more servers, one or more other mobile devices, one or more peripheral devices, etc.). In another example, via one or more of communication links 105, 109, 113, 117, an access point (AP) device 108, and/or network(s) 110, mobile device 104 may, in certain implementations, communicate with one or more electronic device(s) 116 (e.g., one or more servers, one or more other mobile devices, one or more peripheral devices, etc.). Although shown as a wired communication links, in certain instances, communication links 113 and 117 may comprise one or more wired and/or wireless communication links.

AP 108 is intended to generally represent any terrestrial based transmitting device. Hence, AP 108 may comprise an access point, wireless router, and/or the like that may be provisioned as part of a wireless local area network (WLAN), and/or a cellular base transceiver station, a femtocell device, a picocell device, a cellular repeater device, and/or the like that may be provisioned as part of a cellular communication network, and/or some other device that may be provide access to one or more services, networks, etc. Indeed, in certain instances AP 108 may be provisioned as part of network(s) 110.

In FIG. 1, mobile device 104 is representative of any electronic device capable of being moved in some manner. Hence, by way of example, mobile device 104 may comprise a cellular telephone, a smart phone, a tablet computer, a laptop computer, a wearable computer, a navigation and/or tracking device, etc. As illustrated, mobile device 104 may comprise an apparatus 106, which may be configured to provide and/or support in some manner one or more of the techniques provided herein. In certain instances, apparatus 106 may comprise hardware/firmware components, or possibly a combination of hardware/firmware and software components.

Although certain communication links are illustrated in FIG. 1 as being either wireless communication links or wired communication links, it should be kept in mind that some communication links may comprise wired and/or wireless communication links, and/or even other intervening and/or supporting devices, etc.

Network(s) 110 is intended to represent all or part of one or more other electronic devices and/or communication facilities and/or resources capable of supporting wired and/or wireless electronic communication. Thus for example, network(s) 110 may comprise all or part of a telephone network, a cellular telephone network, a wireless communication network, an intranet, the Internet, and/or the like or some combination thereof.

As further illustrated, in certain implementations arrangement 100 may comprise one or more space positioning systems (SPS) 130, which may transmit wireless signals that may, at times, be acquired by mobile device 104 and used, at least in part, to support a positioning function and/or the like under certain conditions. Here, for example, SPS 130 may comprise a plurality of space vehicles (SVs) 132, each of which may transmit one or more SPS signals 134.

As illustrated in FIG. 1, a local transmitter 120 may be provisioned within vehicle 102, which may communicate with mobile device 104, and/or other electronic devices, e.g., via communication link 121. By way of example, in certain implementations local transmitter 120 may be configured to communicate with mobile devices within or nearby vehicle 102. For example, local transmitter 120 may comprise a Bluetooth or other like device capable of communicating with mobile device 104. For example, content files may be communicated by mobile device to local transmitter 120 for replay/display over other devices (not shown) within vehicle 102. In certain instances, information regarding certain aspects of vehicle 102 may be provided to or obtained by mobile device 104 via local transmitter 102. Here, for example, motion-related, navigation-related, and/or other like status information may be provided/exchanged. In certain instances, supplemental evidence of motion state may be obtained based on one or more signals obtained by mobile device 104 from local transmitter 120.

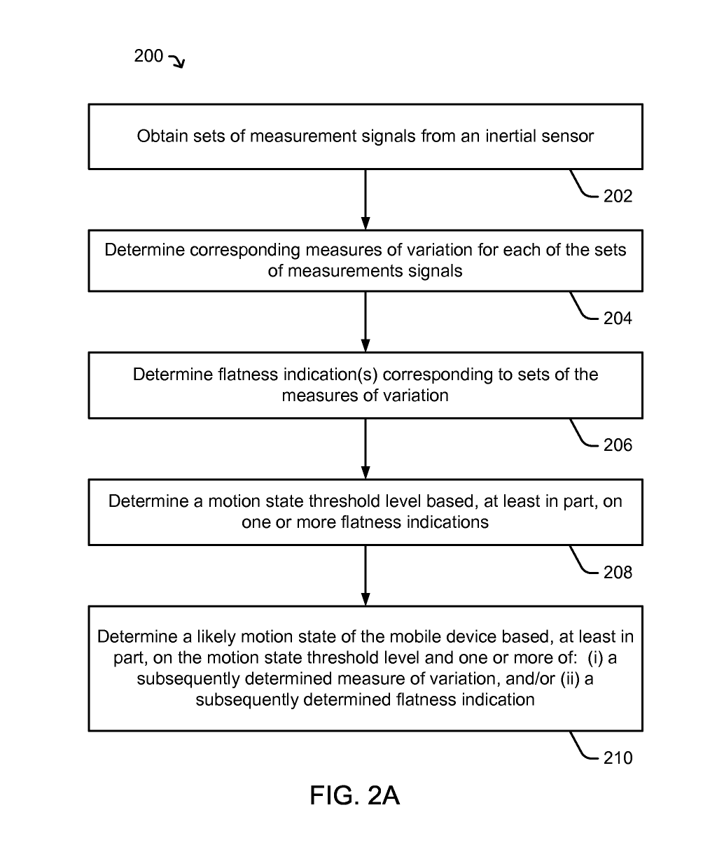

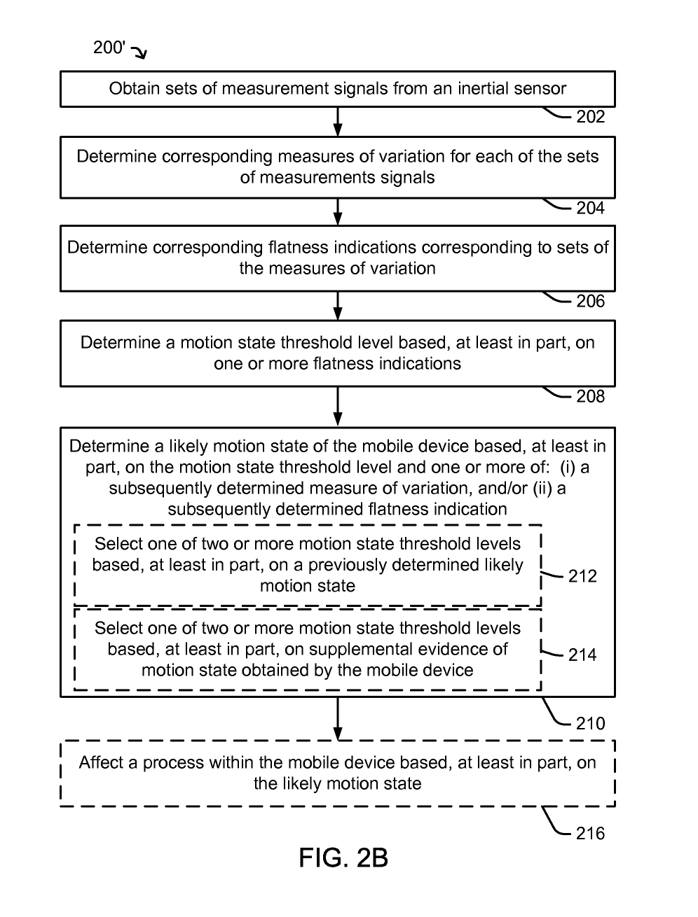

Attention is drawn next to FIG. 2A, which is a flow diagram illustrating an example process 200 that may be implemented in mobile device to determine a likely motion state, in accordance with an example implementation. By way of example, in certain instances 200 may be implemented in mobile device 104 and/or apparatus 106.

At example block 202, two or more sets of measurement signals from an inertial sensor may be obtained. As previously mentioned, in certain example implementations, a set of measurement signals may comprise digital signals representing certain sensed inertial movements pertaining to a particular (sensed) dimension sampled or otherwise gathered over some period of time.

At example block 204, corresponding measures of variation may be determined for each of the sets of measurements signals obtained at block 202. For example, in certain implementations, a variance may be determined for each set of measurement signals at block 204. At example block 206, flatness indications corresponding to sets of the measures of variation may be determined. For example, in certain implementations, a variance of a set of measures of variation may be determined at block 206.

At example block 208 a motion state threshold level may be determined based, at least in part, on one or more flatness indications. As previously mentioned, in certain implementations, a motion state baseline threshold level may be indicative of a particular transition between two motion states. In certain instances, there may be a common motion state baseline threshold level indicative of a transition from a first likely motion state to a second likely motion state, and vice versa. In certain other instances, there may be separate (possibly asymmetrical) motion state baseline threshold levels, e.g., one indicative of a transition from a first likely motion state to a second likely motion state, and another indicative of a transition from the second likely motion state to the first likely motion state.

Thus, in accordance with certain aspects of the present description, with process 200, and in particular examples with example blocks 202, 204, 206, and 208, one or more motion state threshold levels may be dynamically and/adaptively determined by obtaining and processing measurement signals accordingly.

At example block 210, a likely motion state of mobile device 104 (FIG. 1) may be determined based, at least in part, on one or more motion state threshold levels. For example, in certain implementations, at block 210 one or more subsequently determined measures of variation (e.g., determined via the same or similar process in example blocks 202 and 204) may be compared or otherwise taken into consideration with a motion state threshold level (as determined above at block 208). For example, in certain implementations, at block 210 one or more subsequently determined flatness indications (e.g., determined via the same or similar process in example blocks 202, 204, and 206) may be compared or otherwise taken into consideration with a motion state threshold level (as determined above at block 208).

It should be understood that in certain example implementations, all or part of process 200 may be performed with regard to a particular sensed dimension. For example, with regard to a sensed dimension relating to an “x direction”, blocks 202, 204, 206 and 208 (and possibly block 210) may be performed using measurement signals from an x-axis accelerometer sensor, or a roll (rotation about an x-axis) gyroscope sensor. For example, with regard to a sensed dimension relating to a “y direction”, blocks 202, 204, 206 and 208 (and possibly block 210) may be performed using measurement signals from a y-axis accelerometer sensor, or a pitch (rotation about a y-axis) gyroscope sensor. For example, with regard to a sensed dimension relating to a “z direction”, blocks 202, 204, 206 and 208 (and possibly block 210) may be performed using measurement signals from a z-axis accelerometer sensor, or a pitch (rotation about a y-axis) gyroscope sensor.

Hence, in certain implementations, example block 210 may determine a likely motion state of the mobile device with regard to one or more sensed dimensions. Depending on the processing that may be affected by a determined likely motion state, one or more likely motion states for one or more sensed dimensions may be determined via process 200. For example, if subsequent processing may only be concerned with a particular one or two sensed dimensions, then process 200 may only need to address such concerns. In another example, if subsequent processing be affected by any non-static motion state determination, then process 200 may be ended upon determining that a likely non-static motion state exists for at least one of the sensed dimensions.

Nonetheless, in certain implementations, all or part of example process 200 may be concurrently performed for two or more sensed dimensions, and/or two or more inertial sensors. As such, in certain implementations, a likely motion state determination (e.g., at example block 210) may correspond to two or more sensed dimensions, and hence may be based, at least in part, on two or more motion state threshold levels, etc.

FIG. 2B is a flow diagram illustrating example process 200′ that may be implemented in a mobile device to determine a likely motion state, in accordance with certain further example implementations. By way of example, in certain instances 200′ may be implemented in mobile device 104 and/or apparatus 106.

Example process 200′ comprises example blocks 202, 204, 206, 208, and 210 as previously described and illustrated in FIG. 2A. Here, at example block 210, if two or more motion state threshold levels have been determined (e.g., at block 208) and/or otherwise obtained (e.g., predetermined, default, etc.), then at example block 212 one of the motion state threshold levels may be selected based, at least in part, on a previously determined or otherwise obtained likely motion state. For example, assuming that there are two motion state threshold levels with regard to two likely motion states, wherein a first motion state threshold level applies to transitions from a first motion state to a second motion state, and a second motion state threshold level applied to transitions from the second motion state to the first motion state. As such, at block 212, a previous (e.g., most recent, most trusted, etc.) motion state is considered in selecting between the two motion states. Hence, if the previous motion state is the first motion state, then the first state threshold level may be selected. Conversely, if the previous motion state is the second motion state, then the second state threshold level may be selected.

At example block 214, supplemental evidence of motion state obtained by the mobile device may be considered in selecting a likely motion state for use in determining a likely motion state (and/or possibly in determining a likely motion state). For example, as previously mentioned, in certain instances, a mobile device may obtain supplemental evidence of motion state based, at least in part, on one or more wireless signals acquired by the mobile device. For example, certain changes over time in one or more signal characteristics of a wireless signal acquired by the mobile device from a transmitter having a known fixed or other determinable location may be indicative of a likely motion state. Thus, for example, with respect to FIG. 1, in certain instances, one or more wireless signals from SPS 130, AP 108, network(s) 110 may be considered. In certain instances, a presence or absence, some characteristic of a wireless signal 121 (e.g., Bluetooth, etc.) from local transmitter 120 may be considered. Indeed, in certain instances, information obtained via wireless signal 121 (e.g., from vehicle 102) may be considered (in process 200 or 200′). As previously mentioned, in certain instances, a mobile device may obtain supplemental evidence of motion state based, at least in part, on a user input and/or from one or more other sensors provisioned within the mobile device.

At example block 216, one or more processes within the mobile device may be affected in some manner (e.g., adjusted, started, stopped, delayed, extended, repeated, etc.) based, at least in part, on a likely motion state (e.g., as determined at block 208.

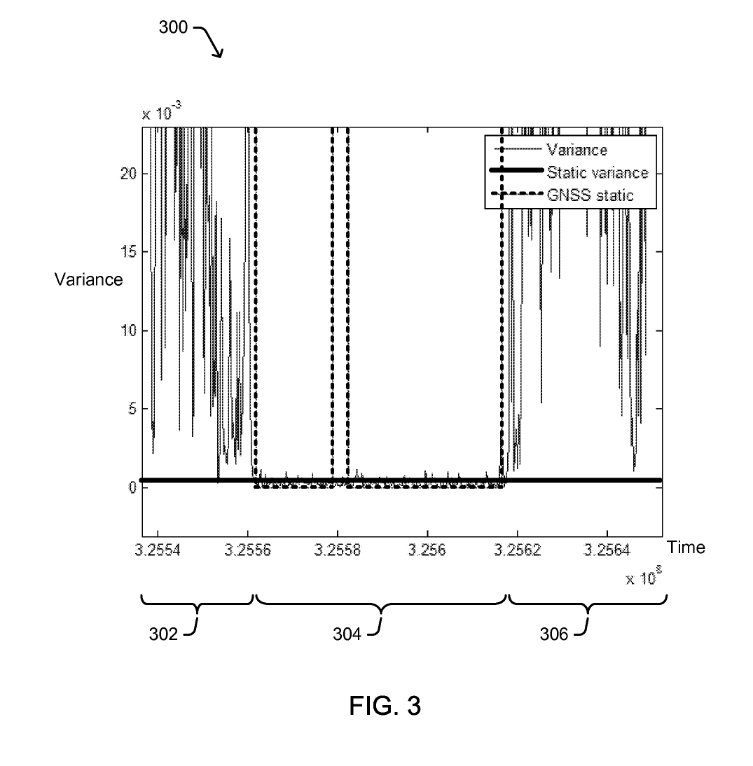

FIG. 3 is a graph 300 illustrating certain characteristics that may observable or otherwise considered by various techniques provided herein for determining a likely motion state of a mobile device, in accordance with an example implementation. As shown, the horizontal axis shows time and the vertical axis shows a variance, and example measures of variation (here, variances for sets of measurement signals) are shown by the thinner line, while an example static variance is shown by the flat heaviest line, and a GNSS static motion (e.g., an example of supplemental evidence of motion) is indicated by the medium weighted dashed line. Here, in this example, in time duration 302 and time duration 306, the variances for the sets of measurement signals vary greatly in there magnitude, while in stark contrast in this example, the variances for the sets of measurement signals in the intervening time duration 304 appear to be substantially similar in magnitude. Accordingly, flatness indications (e.g., based on a set of two or more variances) corresponding to all or part of time duration 304 should be substantially different from flatness indications corresponding to all or part of time durations 302 and/or 304. As such, in this example a mobile device may determine a motion state threshold level based, at least in part, on one or more flatness indications corresponding to all or part of time duration 304. Indeed, as shown in this example, the variations in time duration 304 are near to the static variance and appear to significantly coincide with the example GNSS static motion. Hence, it may be reasonable to determine a motion state threshold level based on such applicable flatness, which may be applied in determining a likely motion state (e.g., for a static state, for a transition to a static state, for transition away from a static state).

Conversely, in certain instances a mobile device may determine a motion state threshold level based, at least in part, on one or more flatness indications corresponding to all or part of time durations 302 and/or 306. As shown in this example, the variations in time durations 302 and 306 are far from the static variance and appear to significantly coincide with the loss of the example GNSS static motion. Hence, it may be reasonable to determine a motion state threshold level based on such applicable (lack of) flatness, which may be applied in determining a likely motion state (e.g., for a non-static state, for a transition to a non-static state, for transition away from a non-static state).

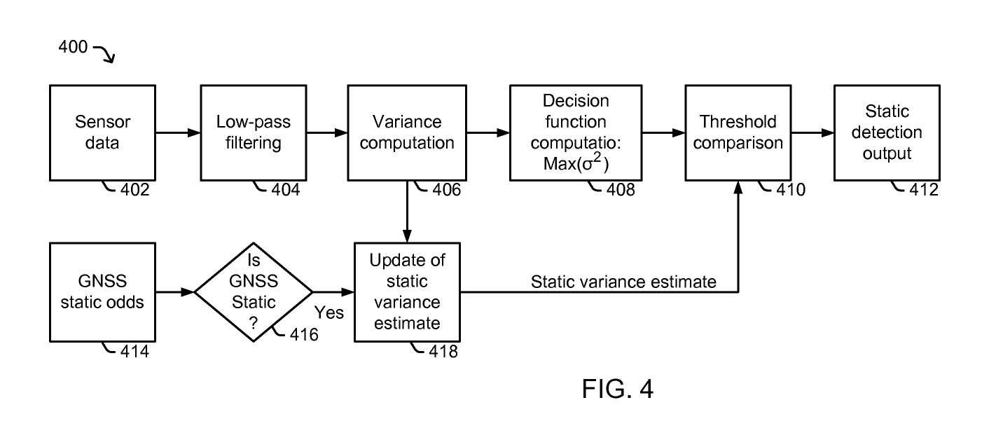

FIG. 4 is a flow diagram illustrating an example process 400 that may be implemented in a mobile device to support a determination regarding its likely motion state, in accordance with certain further example implementations.

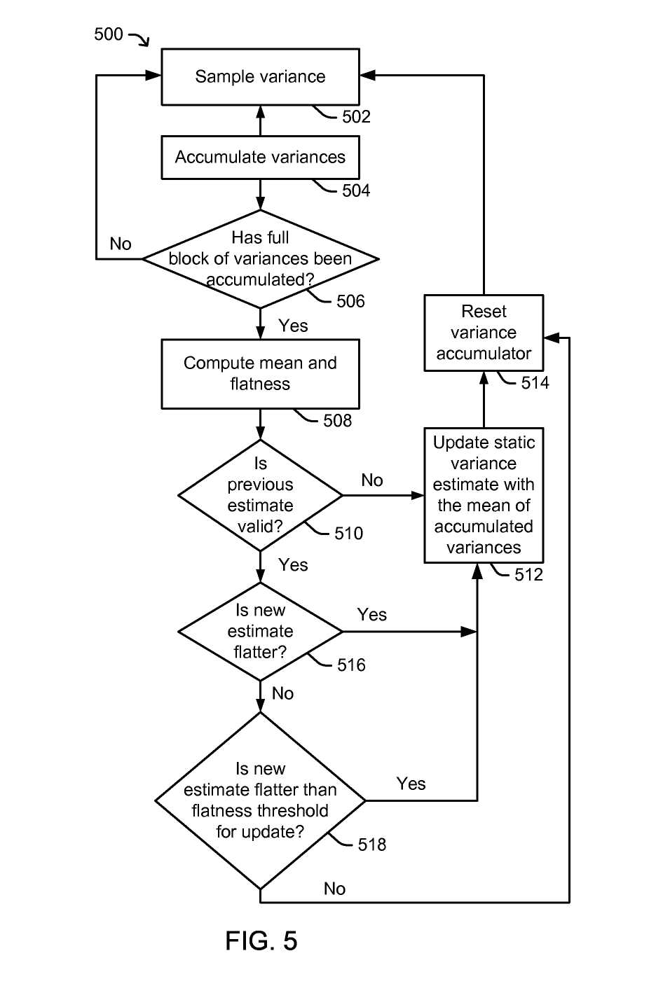

FIG. 5 is a flow diagram illustrating an example process that may be implemented in a mobile device to support a determination regarding its likely motion state, in accordance with certain further example implementations

In furtherance of the above description, some additional example implementations and/or aspects will now be described.

Measurements from an inertial sensor for use in a navigation system, such as an accelerometer or a gyroscope, are typically calibrated for physical changes effecting measurements that may introduce biases. Sensor measurements from an integrated navigation system sensor measurements may be handled differently depending on whether a navigation device may be deemed to be stationary (e.g., in a static state) or mobile (e.g., in a non-static state). For example, a stationary (and implicitly non-rotating) device may provide an effective condition for calibrating gyroscope biases. Conversely, an error in bias estimation may be introduced if a motion detector indicates that a mobile device is static if the device is in fact not static.

In a particular implementation, zero motion detection (ZMD) may be based, at least in part, on signals generated by sensors such as a three dimensional gyroscope or three dimensional accelerometer. A likelihood of being static may be characterized based, at least in part, on ZMD inferred from inertial sensors in addition to acquisition of SPS signals (e.g., from change in carrier phase), WWAN or WLAN signals. One implementation of a stationary position indicator may assess a level of variation in measurements from an accelerometer or gyroscope in at least one axis (e.g., with regard to a sensed dimension). In another implementation, a mobile device may be inferred to be in motion (a non-static state) or a static state based, at least in part, on estimates of a noise floor (e.g., one or more of which may be represented by one or more motion state threshold levels) in the variations in measurement signals from at least one axis of an accelerometer and/or gyroscope sensor. Another implementation may combine a level of variation in measurements from an accelerometer or gyroscope with such estimates of a noise floor (maintained in a memory) of previous outcomes (e.g., hysteresis). Accordingly, there may be asymmetric motion state threshold levels for transitioning between static and non-static states (e.g., exceeding a first threshold level to transition from static to non-static if the unit is previously static, and variation of less than a second threshold to transition from the non-static to static if the mobile device was previously non-static). Another implementation may employ supplemental evidence of motion, e.g., via complementary SPS signal acquisitions, such as from carrier-phase measurements, to combine with the sensor-based data to indicate device motion.

As mentioned, FIG. 1 illustrates an example coordinate system 140 that may be used, in whole or in part, to facilitate or support measurements obtained from inertial sensors of a mobile device, such as a mobile device 104. Such measurements may be generated based, at least in part, on output signals generated by an accelerometer or gyroscope device according to an implementation. As illustrated, example coordinate system 140 may comprise, for example, three-dimensional Cartesian coordinate system, though claimed subject matter is not so limited. In this illustrated example, motion of mobile device 104 representing, for example, acceleration vibration may be detected or measured, at least in part, with reference to three linear dimensions or axes x, y, and z relative to an origin 141 of example coordinate system 140. It should be appreciated that example coordinate system 140 may or may not be aligned with a body of mobile device 104. It should also be noted that in certain implementations a non-Cartesian coordinate system may be used or that a coordinate system may define dimensions that are mutually orthogonal. As also illustrated, rotational motion of mobile device 104, such as orientation changes about gravity, for example, may be detected or measured, at least in part, with reference to one or two dimensions. For example, in one particular implementation, rotational motion of mobile device 104 may be detected or measured in terms of coordinates (φ, τ), where phi (φ) represents roll or rotation about an x axis, and tau (τ) represents pitch or rotation about a y axis. Additionally, in certain instances a yaw (rotation about a z axis) may be represented. In other implementations, a gyroscope may measurement rotations with respect to x, y and z orthogonal axes. Accordingly, in an implementation, a 3D accelerometer may detect or measure, at least in part, a level of acceleration vibration as well as a change about gravity with respect to roll or pitch dimensions, for example, thus, providing five dimensions of observability (x, y, z, φ, τ), or possibly six dimensions with the inclusion of yaw. It should be understood, however, that these are merely examples of various motions that may be detected or measured with reference to example coordinate system 140, and that claimed subject matter is not limited to these particular motions or coordinate system.

According to an implementation, in addition to a level of acceleration vibration, an activity state of a user co-located with mobile device 104 may be inferred. For example, as will be seen, an inertial sensor, such as a 3D accelerometer may be employed, at least in part, to monitor acceleration vibration along x, y, z axes as well as the rotation about gravity with respect to roll (φ) or pitch (τ) angles (or possibly yaw), thus, providing five dimensions (or possibly six dimension) of observability.

In particular implementations, a hybrid of Stationary Position Indicator (SR) and adaptive noise floor estimation algorithms may be used for zero motion detection. Here, such an algorithm may combine a variance-threshold method of SPI with adaptive static distribution estimation. The SPI algorithm may use only accelerometer measurements, but a hybrid may also use gyroscope measurements for static detection; for the final result, accelerometer and gyroscope decisions are combined to generate a single decision.

An example of such an algorithm is shown in FIG. 4, which includes measurement processing, static variance estimation and static detection.

In a particular implementation, sensor data (e.g., measurement signals) at example block 402 may be processed through low-pass filtering at block 404, followed by computation of a variance and/or the like at blocks 406 and/or 408. Low-pass filtering and computation of variance may be computed separately for each accelerometer channel (noise floor x, y, z). In certain instances, variances from the three channels may be combined as follows:

σᵢ²=σ_{x,i}²+σ_{y,i}²+σ_{z,i}²

A sum of variances may be stored in a variance FIFO buffer for later use in motion state detection (see FIG. 5). A variance may be computed over a processing window.

According to an implementation, static variance estimation may attempt to estimate sensor measurement variance while the vehicle is static, in order to produce a reference for static detection from measurement variances. An effective noise floor estimator may have at least the following characteristics:
1. May be close to actual average static variance level, e.g., it is not biased;
2. May not be easily confused by variance inputs when mobile device is actually moving and GNSS indicates static;
3. Estimates may change in both directions: to lower, and to higher; and
4. Estimate a noise floor preferably too low, than too high (e.g., in certain instances, it may be more critical to avoid a false detection of a static state than to not detect a static state when the state may in fact be static).

According to an implementation, with blocks 414, 416 and 418, an estimator may be enabled to compute/estimate a likelihood of a static state based on SPS measurements (e.g., based on change or lack of change in measured signal carrier phase) as an indicator whether current variance measurements are from a static or moving vehicle state. However, as such a likelihood estimate may only be a rough indicator of being in a static/moving state, they must be taken only as a suggestion that we might be static, and further screening of incoming sample variances may be desired.

FIG. 3 shows a plot of variance, noise floor and GNSS static. It has been observed, that when vehicle 102 is static, the consecutive sample variances form a low “plateau” (e.g., variances are low and form a continuous “flat” variance sequence) where variances are relatively close to each other. This suggests that “flatness” of a set of variance measurements can be used as an indicator of whether all of the variances in the set are from an actual static period.

The noise floor estimation algorithm may divide sample variance measurements from GNSS static periods into configurable length blocks, which may then be processed individually and used to update current noise floor estimate. At block 410, a threshold comparison may be performed, and based, at least in part, using a static detection output, e.g., that may be generated at block 412.

Example process 500 in FIG. 5 illustrates certain example actions, including sampling of variances at block 502, accumulating of variances at block 504, and decision block 506 to insure that a full block of variances have been accumulated. Hence, process 500 may return to block 502 in response to an answer of no at block 506, or continue to block 508 in response to an answer of yes at block 506.

At block 508 mean variance and flatness may be determined, followed by decision blocks 510, 516 and 518. At block 510, a decision may be made as to whether a previous estimate is valid. In response to a yes answer, process 500 may continue at block 516, wherein a decision may be made as to whether a new estimate is flatter than a previous estimate. In response to a no answer, process 500 may continue at block 518, a decision may be made as to whether a new estimate is flatter than a threshold value for an update. If the answer at block 510 is no, or the answer at block 516 is yes, or the answer at block 518 is yes, then process 500 may continue at block 512, wherein a static variance estimate (e.g., one type of a motion state threshold level) may be updated with the means of accumulated variances. If the answer at block 518 is no, or following block 512, process 500 may continue at block 514, wherein the variance accumulator may be reset.

Where applicable, certain processes and their implemented algorithms may, for example, compute (1) the mean of variances to be the new noise floor estimate, and (2) variance of variances to represent the “flatness” of the variances. In order to have a flatness indicator which is scale independent and dimensionless, the variances of variances may be divided with square of mean as follows:

$$\vert flatness = \frac{{σ}_{{σ}^{2}}^{2}}{{μ}_{{σ}^{2}}^{2}}$$

This may, for example, be implemented as a squared coefficient of variation (of variances). Other techniques for assessing “flatness” may include Kurtosis, for example.

After an algorithm has determined a new estimate and its “flatness”, it may update a current noise floor estimate if any of the following conditions is true:
a. Previous estimate is not valid, so that an estimate is available as soon as possible (see block 510);
b. New estimate is more “flat”, i.e. has smaller squared variation, so that we always use “flatter” estimate (see block 516); and
c. New estimate is “flatter” than specified threshold, so that we don't get stuck into accidentally very “flat” estimates, and can continue following true noise floor (see block 518).

After a decision has been made that a noise floor estimate may be updated with a mean of variances in a current block, an update may be performed depending on values of the new and the current estimates as shown in process 500 (e.g., at block 512). If a new estimate is smaller than a current estimate, it may indicate that a current noise floor estimate may be updated by replacing it with a new noise floor estimate. However, if a new noise floor estimate is larger, the current noise floor estimate may be computed as weighted average between old and new noise floor estimates. This may enable the estimate to move in multiple directions, but prefer direction which prefers false negatives over false positives.

According to an implementation, static detection may begin by computation of a decision function, which is defined as the maximum variance during an interval before the detection time. The decision function is then scaled by dividing it by the noise floor estimate, and compared against static detection threshold to obtain the decision:

$$decision = \frac{Max ( {σ}_{sample}^{2} )}{{σ}_{static}^{2}} < threshold$$

Detections may then be stored into separate buffers for each sensor (accelerometer, gyroscope). When the stationary decision is requested for a detection interval, the decisions for accelerometer and gyroscope are combined from that interval; thus, both sensors may be used for static detection, and even one sensor can make the combined decision non-static.

All or part of the techniques presented in algorithmic processes 400 and/or 500 may be implemented in certain instances by mobile device 104 and/or apparatus 106, e.g., within and/or to support all or part of the techniques of processes 200 and/or 200′, and/or the like.

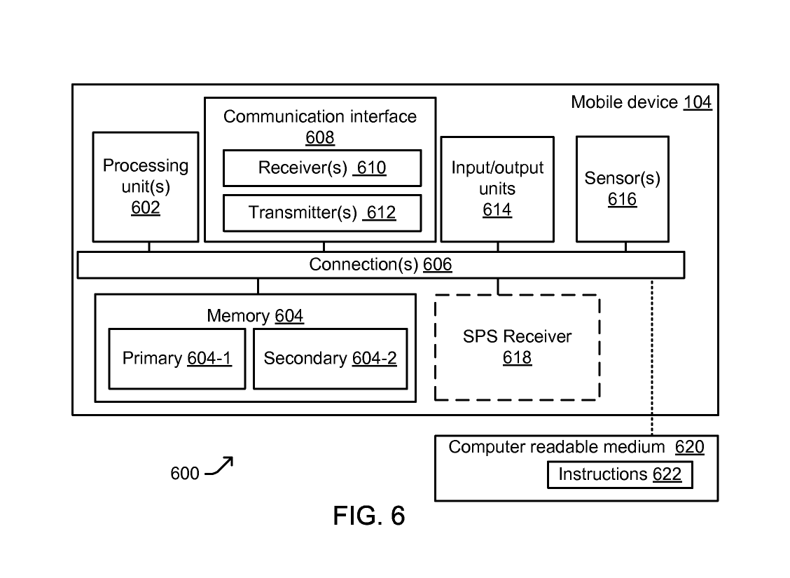

Attention is now drawn to FIG. 6, which is a schematic diagram illustrating certain features of an example computing platform 600 that may be provisioned within a mobile device 104 (and/or apparatus 106) capable of determining its likely motion state, in accordance with an example implementation.

As illustrated computing platform 600 may comprise one or more processing units 602 (e.g., to perform data processing in accordance with certain techniques provided herein) coupled to memory 604 via one or more connections 606 (e.g., one or more electrical conductors, one or more electrically conductive paths, one or more buses, one or more fiber-optic paths, one or more circuits, one or more buffers, one or more transmitters, one or more receivers, etc.). Processing unit(s) 602 may, for example, be implemented in hardware or a combination of hardware and software. Processing unit(s) 602 may be representative of one or more circuits configurable to perform at least a portion of a data computing procedure or process. By way of example but not limitation, a processing unit may include one or more processors, controllers, microprocessors, microcontrollers, application specific integrated circuits, digital signal processors, programmable logic devices, field programmable gate arrays, or the like, or any combination thereof.

Memory 604 may be representative of any data storage mechanism. Memory 604 may include, for example, a primary memory 604-1 and/or a secondary memory 604-2. Primary memory 604-1 may comprise, for example, a random access memory, read only memory, etc. While illustrated in this example as being separate from the processing units, it should be understood that all or part of a primary memory may be provided within or otherwise co-located and coupled with processing unit 602 or other like circuitry within mobile device 104. Secondary memory 604-2 may comprise, for example, the same or similar type of memory as primary memory and/or one or more data storage devices or systems, such as, for example, a disk drive, an optical disc drive, a tape drive, a solid motion state memory drive, etc.

In certain implementations, secondary memory may be operatively receptive of, or otherwise configurable to couple to, a non-transitory computer readable medium 620. Memory 604 and/or non-transitory computer readable medium 620 may comprise instructions 622 for use in performing data processing, e.g., in accordance with the applicable techniques as provided herein.

Computing platform 600 may, for example, further comprise a communication interface 608. Communication interface 608 may, for example, comprise one or more wired and/or wireless network interface units, radios, modems, etc., represented here by one or more receivers 610 and one or more transmitters 612. It should be understood that in certain implementations, communication interface 608 may comprise one or more transceivers, and/or the like. Further, it should be understood that although not shown, communication interface 608 may comprise one or more antennas and/or other circuitry as may be applicable given the communication interface capability.

In accordance with certain example implementations, communication interface 608 may, for example, be enabled for use with various wired communication networks, e.g., such as telephone system, a local area network, a wide area network, a personal area network, an intranet, the Internet, etc.

In accordance with certain example implementations communication interface 608 may, for example, be enabled for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMBP capability), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., “4G”), such as, for example, Long Term Evolution (LTE), Advanced LTE, WiMAX, Ultra Mobile Broadband (UMB), and/or the like. Additionally, communication interface(s) 308 may further provide for infrared-based communications with one or more other devices. A WLAN may, for example, comprise an IEEE 802.11x network, and a WPAN may comprise a Bluetooth network, an IEEE 802.15x, for example. Wireless communication implementations described herein may also be used in connection with any combination of WWAN, WLAN or WPAN.

Mobile device 104 may, for example, further comprise one or more input and/or output units 614. Input and/or output units 614 may represent one or more devices or other like mechanisms that may be used to obtain inputs from and/or provide outputs to one or more other devices and/or a user. Thus, for example, input and/or output units 614 may comprise various buttons, switches, a touch pad, a trackball, a joystick, a touch screen, a keyboard, a microphone, a camera, and/or the like, which may be used to receive one or more user inputs. In certain instances, input and/or output units 614 may comprise various devices that may be used in producing a visual output, an audible output, and/or a tactile output for a user. For example, input and/or output units 614 may be used to present a video display, graphical user interface, positioning and/or navigation related information, visual representations of electronic map, routing directions, etc., via a display mechanism and/or audio mechanism.

Mobile device 104 may, for example, comprise one or more sensors 616. For example, sensor(s) 616 may represent one or more environmental sensors, such as, e.g., a magnetometer or compass, a barometer or altimeter, etc., and which may be useful for positioning. For example, sensor(s) 616 may represent one or more inertial sensors, which may be useful in detecting certain movements of mobile device 104. Thus for example, sensor(s) 616 may comprise one or more accelerometers, one or one or more gyroscopes. Further, in certain instances sensor(s) 616 may comprise and/or take the form of one or more input devices such as a microphone, a camera, a light sensor, etc.

SPS receiver 618 may be capable of acquiring and acquiring wireless signals 134 via one or more antennas (not shown). SPS receiver 618 may also process, in whole or in part, acquired wireless signals 134 for estimating a position and/or a motion of mobile device 104. In certain instances, SPS receiver 618 may comprise one or more processing unit(s) (not shown), e.g., one or more general purpose processors, one or more digital signal processors DSP(s), one or more specialized processors that may also be utilized to process acquired SPS signals, in whole or in part, and/or calculate an estimated location of mobile device 104. In certain implementations, all or part of such processing of acquired SPS signals may be performed by other processing capabilities in mobile device 104, e.g., processing unit(s) 602, memory 604, etc., in conjunction with SPS receiver 618. Storage of SPS or other signals for use in performing positioning operations may be performed in memory 604 or registers (not shown).

In certain instances, sensor(s) 616 may generate analog or digital signals that may be stored in memory 604 and processed by DPS(s) (not shown) or processing unit(s) 602 in support of one or more applications such as, for example, applications directed to positioning or navigation operations based, at least in part, on one or more positioning functions.

Processing unit(s) 602 may comprise a dedicated modem processor or the like that may be capable of performing baseband processing of signals acquired and downconverted at receiver(s) 610 of communication interface 608 or SPS receiver 618. Similarly, a modem processor or the like may perform baseband processing of signals to be upconverted for transmission by (wireless) transmitter(s) 612. In alternative implementations, instead of having a dedicated modem processor, baseband processing may be performed by a general purpose processor or DSP (e.g., general purpose and/or application processor). It should be understood, however, that these are merely examples of structures that may perform baseband processing, and that claimed subject matter is not limited in this respect. Moreover, it should be understood that the example techniques provided herein may be adapted for a variety of different electronic devices, mobile devices, transmitting devices, environments, position fix modes, etc.

The techniques described herein may be implemented by various means depending upon applications according to particular features and/or examples. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically motion stated otherwise, as apparent from the following discussion, it is appreciated that throughout this specification discussions utilizing terms such as “processing”, “computing”, “calculating”, “determining”, “generating”, “obtaining”, “modifying”, “selecting”, “identifying”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method comprising, at a mobile device:
obtaining sets of measurement signals from an inertial sensor;
determining corresponding measures of variation for each of said sets of measurement signals;
determining flatness indications corresponding to sets of said measures of variation;
determining a motion state threshold level based, at least in part, on one or more flatness indications; and
determining a likely motion state of said mobile device based, at least in part, on said motion state threshold level and one or more of: (i) a subsequently determined measure of variation, and/or (ii) a subsequently determined flatness indication.

2. The method as recited in claim 1, wherein two or more motion state threshold levels are available, and the method further comprises:
selecting one of said two or more motion state threshold levels for use in determining said likely motion state of said mobile device based, at least in part, on a previously determined likely motion state.

3. The method as recited in claim 2, wherein a first one of said two or more motion state threshold levels is selected for use in determining said likely motion state of said mobile device in response to said previously determined likely motion state indicating a static state, and wherein a second one of said two or more motion state threshold levels is selected for use in determining said likely motion state of said mobile device in response to said previously determined likely motion state indicating a motion state.

4. The method as recited in claim 1, wherein two or more motion state threshold levels are available, and the method further comprises:
selecting one of said two or more motion state threshold levels for use in determining said likely motion state of said mobile device based, at least in part, on supplemental evidence of motion state obtained by said mobile device.

5. The method as recited in claim 1, and further comprising obtaining supplemental evidence of motion state based, at least in part, on one or more of: a wireless signal acquired by said mobile device, a user input obtained by said mobile device, and/or one or more signals from a magnetometer provisioned within said mobile device.

6. The method as recited in claim 1, and further comprising: affecting a process within said mobile device based, at least in part, on said likely motion state.

7. The method as recited in claim 6, wherein said process comprises a calibration process corresponding to said inertial sensor.

8. A mobile device comprising:
an inertial sensor; and
a processing unit to:
obtain sets of measurement signals from said inertial sensor;
determine corresponding measures of variation for each of said sets of measurement signals;
determine flatness indications corresponding to sets of said measures of variation; and
determine a motion state threshold level based, at least in part, on one or more flatness indications; and determine a likely motion state of said mobile device based, at least in part, on said motion state threshold level and one or more of: (i) a subsequently determined measure of variation, and/or (ii) a subsequently determined flatness indication.

9. The mobile device as recited in claim 8, and further comprising:
memory; and
wherein two or more motion state threshold levels are available, and said processing unit to further select one of said two or more motion state threshold levels for use in determining said likely motion state of said mobile device based, at least in part, on a previously determined likely motion state as stored in said memory, and wherein a first one of said two or more motion state threshold levels is selected for use in determining said likely motion state of said mobile device in response to said previously determined likely motion state indicating a static state, and wherein a second one of said two or more motion state threshold levels is selected for use in determining said likely motion state of said mobile device in response to said previously determined likely motion state indicating a motion state.

10. The mobile device as recited in claim 8, and further comprising:
memory; and
wherein two or more motion state threshold levels are available, and said processing unit to further select one of said two or more motion state threshold levels for use in determining said likely motion state of said mobile device based, at least in part, on supplemental evidence of motion state stored in said memory, and said processing unit to further determine said likely motion state of said mobile device based, at least in part, on the supplemental evidence of motion state stored in said memory.

11. The mobile device as recited in claim 8, and further comprising:
a communication interface; and said processing unit to obtain supplemental evidence of motion state based, at least in part, on wireless signals acquired by said mobile device via said communication interface.

12. The mobile device as recited in claim 8, and further comprising:
an input device; and
said processing unit to obtain supplemental evidence of motion state based, at least in part, on a user input obtained by said mobile device via said input device.

13. The mobile device as recited in claim 8, and further comprising:
a magnetometer; and
said processing unit to obtain supplemental evidence of motion state based, at least in part, on one or more signals from the magnetometer.

14. The mobile device as recited in claim 8, said processing unit to:
affect a process within said mobile device based, at least in part, on said likely motion state.

15. An article comprising:
a computer readable medium having stored therein computer implementable instructions executable by a processing unit of a mobile device to:
obtain sets of measurement signals from an inertial sensor;
determine corresponding measures of variation for each of said sets of measurement signals;
determine flatness indications corresponding to sets of said measures of variation;
determine a motion state threshold level based, at least in part, on one or more flatness indications; and
determine a likely motion state of said mobile device based, at least in part, on said motion state threshold level and one or more of: (i) a subsequently determined measure of variation, and/or (ii) a subsequently determined flatness indication.

16. The article as recited in claim 15, wherein two or more motion state threshold levels are available, and said computer implementable instructions are further executable by said processing unit to:
select one of said two or more motion state threshold levels for use in determining said likely motion state of said mobile device based, at least in part, on a previously determined likely motion state.

17. The article as recited in claim 16, wherein a first one of said two or more motion state threshold levels is selected for use in determining said likely motion state of said mobile device in response to said previously determined likely motion state indicating a static state, and wherein a second one of said two or more motion state threshold levels is selected for use in determining said likely motion state of said mobile device in response to said previously determined likely motion state indicating a motion state.

18. The article as recited in claim 15, wherein two or more motion state threshold levels are available, and said computer implementable instructions are further executable by said processing unit to:
select one of said two or more motion state threshold levels for use in determining said likely motion state of said mobile device based, at least in part, on supplemental evidence of motion state obtained by said mobile device.

19. The article as recited in claim 15, wherein said computer implementable instructions are further executable by said processing unit to:
determine said likely motion state of said mobile device based, at least in part, on supplemental evidence of motion state obtained by said mobile device.

20. The article as recited in claim 15, wherein said computer implementable instructions are further executable by said processing unit to:
affect a process within said mobile device based, at least in part, on said likely motion state.
